(19) United States
(12) Patent Application Publication
(10) Pub. No.: US 2005/0244024 A1
(43) Pub. Date: Nov. 3, 2005

(54) Hearing aid with a resonator carried by the hearing aid housing

(76) Inventors: Thomas Fischer, Erlangen (DE); Wolfgang Kramer, Erlangen (DE); Gottfried Ruckerl, Nurnberg (DE)

Correspondence Address: SCHIFF HARDIN, LLP;PATENT DEPARTMENT, 6600 SEARS TOWER, CHICAGO, IL, 60606-6473, US

(21) Appl. No.: 11/104,769

(22) Filed: Apr. 13, 2005

(30) Foreign Application Priority Data
Apr. 13, 2004 (DE) 10 2004 017 832.1

(51) Int. Cl. H04R 25/00

(52) U.S. Cl. 381/331

(57) ABSTRACT

For reducing the installation space necessary for an antenna in a hearing aid, the antenna is formed as an electrically conducting layer in the material of the housing or on the hearing device housing. In this way, the housing is used as a carrier material for the antenna and it is possible to dispense with the space that otherwise has to be provided for the antenna, such as on the printed circuit board.

### BACKGROUND OF THE INVENTION

1. Field of the Invention

The present invention relates to a hearing device of the type having a housing and an RF antenna and/or electrical coil for electromagnetic energy and/or data transmission.

2. Description of the Prior Art

It is usually endeavored to make hearing devices as small as possible. In order to increase the functionality of the hearing device, however, as many electronic components as possible are to be accommodated in the hearing device. Therefore, one of the factors limiting the miniaturization of hearing devices and the extent to which they can be fitted with components is the dimensions of, for example, telephone coils, storage battery charging coils or RF antennas for wireless communication.

At the same time, it is attempted to reduce as far as possible the size of the necessary components, such as coils for example, while preserving the desired properties, so that they require only little installation space in the device. For example, RF antennas that are integrated in the printed circuit boards for the electronics of the hearing device are used. Such antennas printed on circuit boards are known for example from the WHITE PAPER “ 1/4 printed monopole antenna for 2.45 GHz” by Nordic VLSI ASA, February 2003.

Furthermore, implantable hearing devices with induction coils are known from the documents U.S. Pat. Nos. 4,495,917 and 6,272,382. In both cases, the coils are embedded in a casting compound on the outer periphery of the respective hearing device. A classic coil construction with a number of turns in numerous planes is used in each case.

A hearing device system with a programmable hearing device and a transmitting and receiving unit is known from the document German OS 101 15 896. An antenna for the transmission and receiving unit is arranged in the housing of the hearing device.

Furthermore, a receiver capsule for persons with impaired hearing with an induction coil is known from German OS 34 43 907. The induction coil is fastened to the receiver capsule by a flange,

A disadvantage of these known coils is that they continue to require relatively considerable installation space.

### SUMMARY OF THE INVENTION

An object of the present invention is to reduce further the size of the installation space that is necessary for coils of hearing devices.

This object is achieved according to the invention by a hearing device with a housing and a resonator such as an RF antenna and/or electrical coil for electromagnetic energy and/or data transmission, wherein the RF antenna and/or the electrical coil is/are formed as an electrically conducting layer in the material of the housing or on the housing.

By forming the coil according to the invention as a conducting layer provided on the hearing device housing or integrated in a housing, the overall volume of a hearing device can be reduced further in size. For some hearing devices, this makes it possible for the first time to integrate an RF system.

The electrically conducting layer preferably is formed by a metallization that has subsequently been patterned. This allows the process for metallizing the hearing device housing to be made very simple.

However, it may also be advantageous to apply the electrically conducting layer as a patterned metal layer to the inside or the outside of the housing. This allows a sometimes complex patterning process to be avoided.

A further variant for the production of an antenna or coil in the form of an electrically conducting layer is to cast the electrically conducting layer in the housing. In this way, the coil or antenna is reliably protected against external mechanical influences.

The electrically conducting layer may, furthermore, consist of a conducting plastic material. This allows the production processes that are customary for plastics to be used for the production of the coil or antenna.

Furthermore, the antenna or coil may be formed by a number of levels of the electrically conductive layer being arranged one on top of the other in or on the housing. In this way, further allowance can be made for the spatial conditions, in particular if high inductances are required.

The coil may also be formed as a conductor running around the housing, about its longitudinal axis. In the case of BTE hearing devices, this has the advantage, for example, that such a coil aligned parallel to the concha of the ear is well suited for use as a telephone coil. Such a coil running around the housing can also be used, however, when the housing is divided longitudinally. In this case, the helical coil is formed by placing the halves of the housing together. Any other conductor pattern may also extend over both housing halves.

### DESCRIPTION OF THE DRAWINGS

FIG. 1 shows a BTE hearing device with an antenna according to a first embodiment of the invention,

FIG. 2 shows a BTE hearing device with an antenna according to a second embodiment of the invention.

FIG. 3 shows an ITE hearing device with an antenna according to a third embodiment of the invention.

### DESCRIPTION OF THE PREFERRED EMBODIMENTS

According to the present invention, a conductor patterned in any desired form is applied to the housing of the hearing device. This preferably takes place on the inside of the hearing device housing, in order to avoid the conductor pattern being damaged by external influences. The conductor pattern may, however, also be applied on the outside of the hearing device housing, it then being recommendable to apply a protective layer over it,

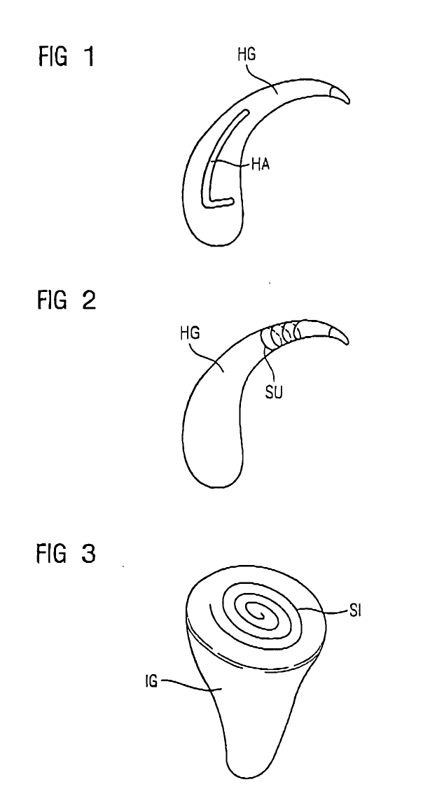

An example of an RF antenna according to the invention formed on the hearing device housing is represented in FIG. 1. The L-shaped RF antenna HA has been applied to the BTE hearing device housing HG as a layer of metal. Depending on the preferred type of production, the RF antenna HA is applied to the hearing device housing HG as a preformed foil structure or is formed by subsequent patterning of a metallization of the hearing device housing HG. Alternatively, the RF antenna HA may be formed as a layer of conducting plastic during the injection-molding of the hearing device housing HG in the desired form.

A further exemplary embodiment of a hearing device according to the invention is reproduced in FIG. 2. The coil SU represented there has a helical character and winds around the housing, which is also represented in this FIG. 2 as a BTE hearing device housing HG. In fact, the coil SU is formed in a portion of the housing and the axis of the coil SU corresponds to the longitudinal axis of the housing portion. In this respect, the “axis” or “longitudinal axis” may also be curved, as in the present case.

A third embodiment of the present invention is sketched in FIG. 3. In this case, a spiral antenna SI is provided on the outwardly facing side of an ITE hearing device housing IG. This hearing device housing IG could, however, also be fitted for example with a coil-shaped antenna, as represented in FIG. 2, in the conical housing region. Conversely, of course, a BTE housing may also be provided with a spiral antenna.

By suitable choice of the conductor geometry, the component created by the conductor layer can be optimally adapted to the respective application. In this way it is possible to influence the gain, the directional effect and the impedance in a corresponding way. In addition, it is also possible for a number of levels of the conductor layer to be placed one on top of the other within the shell layer, in order to use the housing material as a dielectric.

Although modifications and changes may be suggested by those skilled in the art, it is the intention of the inventors to embody within the patent warranted hereon all changes and modifications as reasonably and properly come within the scope of their contribution to the art.

1. A miniaturized hearing aid comprising:
a housing, comprised of housing material, adapted to be worn at or in a human ear; and
a resonator selected from the group consisting of RF antennas and electrical coils, said resonator being formed as an electrically conducting layer carried by said housing material.

2. A hearing aid as claimed in claim 1 wherein said electrically conducting layer is incorporated in said housing material.

3. A hearing aid as claimed in claim 1 wherein said electrically conducting layer is disposed on said housing material.

4. A hearing aid as claimed in claim 1 wherein said resonator is a resonator for electromagnetic energy.

5. A hearing aid as claimed in claim 1 wherein said resonator is a resonator for data transmission.

6. A hearing aid as claimed in claim 1 wherein said conducting layer comprises a patterned metallization.

7. A hearing aid as claimed in claim 1 wherein said electrically conducting layer is a patterned metal layer applied to a surface of said housing selected from the group consisting of an interior surface and an exterior surface.

8. A hearing aid as claimed in claim 1 wherein electrically conducting layer is cast into said housing material.

9. A hearing aid as claimed in claim 1 wherein said electrically conducting layer is comprised of electrically conducting plastic material.

10. A hearing aid as claimed in claim 1 wherein said electrically conducting layer comprises a plurality of layer levels disposed over each other.

11. A hearing aid as claimed in claim 1 wherein said housing has a longitudinal axis, and wherein said resonator is an electrical coil, said coil comprising an electrical conductor proceeding around a portion of said housing, around said longitudinal axis.

12. A hearing aid as claimed in claim 1 wherein said housing is longitudinally divided into two housing halves, with respective portions of said electrically conducting layer being carried by said two housing halves.
